(19) United States
(12) Patent Application Publication
(10) Pub. No.: US 2021/0323385 A1
(43) Pub. Date: Oct. 21, 2021

(54) SYSTEM AND METHOD FOR COOLING AN OPEN AIR VEHICLE

(71) Applicant: Michael SLAUGHTER, Allen, TX (US)

(72) Inventor: Michael SLAUGHTER, Allen, TX (US)

(21) Appl. No.: 16/852,762

(22) Filed: Apr. 20, 2020

(51) Int. Cl. B60H 3/02; B60H 1/00; B60H 3/06

(52) U.S. Cl. CPC B60H 3/022; B60H 1/00871; B60H 3/06; B60H 1/00407

(57) ABSTRACT

A system and method for cooling an open air vehicle is provided. The system comprises a housing mounted on the vehicle configured to hold a water tank and a water filter. The system further comprises a water pump and one or more air blowers coupled to the water pump. The system further comprises a battery configured to supply power to the water pump and the one or more air blowers. The method comprises storing water in a water tank the water tank positioned within a housing on the vehicle. The method further comprises powering a water pump, via a battery, and pumping water from the water pump out of one or misting tips. The method further comprises providing one or more air blowers that distributes cold air and water coming out the misting tips.

### TECHNICAL FIELD

The present technology pertains to a system for cooling and more specifically to a system for cooling an open air vehicle.

### BACKGROUND OF THE INVENTION

Misting systems are used for air conditioning of outdoor environments. A misting system produces a fine mist of water. Current problems exist in cooling open air vehicles, such as effectively cooling users without getting the user wet. Current systems either do not cool the air sufficiently enough to cool the users or can get the user wet because the water pressure in the misting system is too low. This problem is solved by utilizing at least a 160 psi water pump to make the water molecules smaller so they evaporate into the air and adding an air blower so that the user does not get wet. An additional battery is utilized that is distinct from the golf cart batteries and does not use up the power from the golf cart.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of the system for cooling open air vehicles, according to an embodiment;

FIG. 2 is a perspective view of the system, according to an embodiment;

FIG. 3 is a side view of the system, according to an embodiment;

FIG. 4 is a bottom view of the battery and the water pump of the system, according to an embodiment;

FIG. 5 a top view of the water tank and the housing of the system, according to an embodiment.

### SUMMARY OF THE INVENTION

A system for cooling an open air vehicle is provided. In an embodiment, the system comprises a metal basket configured to hold a water tank and a water filter attached to the water tank. The water pump is configured to pump water from the water tank to one or more misting tips configured within a predetermined distance of the air blower. The misting tips may be adjusted by metal coils. The water may be adjusted by one or more valves. The system further comprises a battery configured to supply power to a display, an air blower and a water pump. The system further comprises a battery charger configured to charge the battery.

### DESCRIPTION OF THE EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The subject matter disclosed is related to cooling users (e.g., golfers) on hot, humid days. One problem faced on hot, humid days is the health risk and business decreases when the heat and humidity becomes overwhelming. The subject matter discloses a water misting system that may cool the air, surrounding an open air vehicle (e.g., golf cart), down 20 degrees or more by evaporating water molecules into the air. The system may hold a predetermined amount of water (e.g., 7 gallons, etc.) that may provide a predetermined amount of non-stop usage (e.g., 3 hours, etc.). The water tank may be connected to a 160-1000 psi water pump that pushes the mist out of one or misting tips. The misting tips are on the sides of an air blower that may oscillate at different powers and speed. A 12-voltage deep cycle gel battery may power the entire system. A control box can be configured for easy on and off access for the air blower and one or more misting tips. The equipment may be placed in the front of the golf cart, inside a housing (e.g., metal basket). The equipment and housing may be covered with a waterproof material.

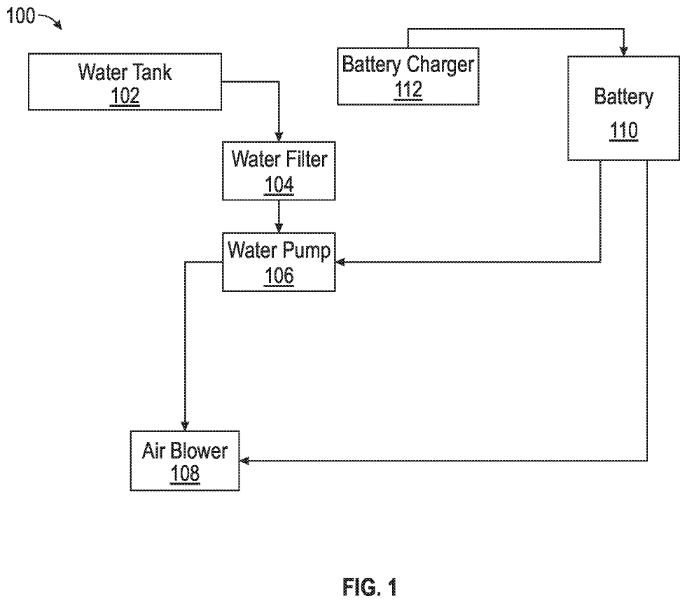

FIG. 1 illustrates a block diagram of the system for cooling open air vehicles, according to an embodiment. The system 100 includes a water tank 102 that may be a class A customs 7 gallon RV Concessions fresh water holding tank NSF/FDA (3 half inch Dia screw fittings)(23.8×9.8×7 inches). In an example, the water tank 102 may have a water hose that connects to a water filter. The water tank 102 connects, via the water hose, to a water pump 106 that may be a 160-1000 psi water pump. A water filter 104 collects from water tank 102 and transfers the water to the water pump 106, via the hose. The water filter 104 may remove debris and particles from the water.

The water pump 106 is provided for pumping the water out of the water tank 102. The water pump 106 is in liquid communication with the water tank 102 via one or more hoses. In some examples, the water pump 106 may comprise a manually operated pump or an electrically powered pump that may be selectively powered. The water tank 102 may be situated inside a housing 214, illustrated in FIG. 4. The water pump 106 may be situated below the housing 214. The housing 214 may be a metal basket or any type of basket configured to hold the water tank 102, the water filter 104, the water pump 106, and the battery 110. In an example, the housing 214 is a Madjax 04-11 front clays steel basket for 1994-up EZGO TXT golf cart (44×17.5×7.5 inches).

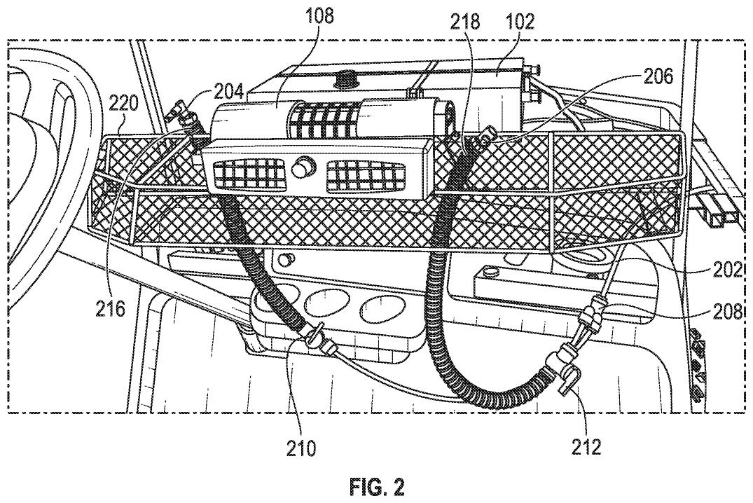

The system 100 may include at least one air blower 108. The air blower may be mounted on another housing 220. The housing 220 may be a metal basket. The housing 220 is configured to hold the air blower 108 and misting tips 204, 206, illustrated in FIG. 2. The air blower 108 may have one or more speeds and an oscillation options (120 v/60 HZ). In an embodiment, the air blower 108 has three speeds and three vents. Air from the air blower 108 directs the mist outwards. In an example, the air blower 108 may include one or more fans. In an embodiment, a control panel may be used to selectively control the speed and power of the water pump 106 and the air blower 108. The battery 110 supplies power to the air blower 108 and the water pump 106.

In another embodiment, the electricity from the battery 110 may be transferred through a power inverter. A power inverter may be a Strongway power inverter (model #7003B). The power inverter converts DC power supplied from the battery 110 into a voltage and outputs the AC voltage to the water pump 106 and air blower 108. The power inverter may include one or more cables. One or more cables may be plugged into a power strip with at least three outlets. In an example, the power strip is made by Tessan. The battery 110 may be a 12-voltage battery. The battery 110 is charged with a battery charger 112. The battery charger 112 may be a 12-voltage deep cycle battery charger. The power inverter may be connected to the water pump 106 in order to change the flow rate of the water. The system may optionally include a LCD display that illustrates real-time power output from the power inverter in real time.

FIG. 2 is a perspective view of the system, according to an embodiment. The water tank 102 supplies the water for the water pump 106. One or more hoses 202 are connected to the water pump 106 and pump water through one or more misting tips 204, 206 to create the mist. The mist elbow 208 connects the hose connected to the air blower 108 to the misting tips 204, 206. Water is run from the water tank 102 into the water pump 106 and through the hose 202 into and out of the misting tips 204, 206 attached to the air blower 108. The air blower 108 propels the mist and provides a finely distributed and atomized water vapor mist to be carried by the high velocity air flow from the air blower 108. The mist evaporates into the air to cool down the temperature 20 degrees or more.

The hose 202 may be 10 feet of ½ inch mist hose. The misting tips 204, 206 may have 0.008/0.2 mm 10/24 threading. The misting elbow may be ¼ inch. The hose 202 may be formed into a multi-branch hose, which is attached to the air blower 108. The air blower 108 may be mounted on the housing 214 in order to blow and distribute the cold air. The hose 202 goes from the water pump 106 into the housing 214.

The hose 202 may have one or more on and off valves 210, 212. The valves 210, 212 are connected to the water tank 102 and water pump 106 and provided for controlling the flow of water through the hose 202 and to the misting tips 204, 206. The valves 210, 212 control the flow through the misting tips 204, 206 for adjusting the amount of cooling desired. The number of hoses and misting tips may vary based on the intended application. In some applications, system may have a single misting tip and hose. In other applications, the system may have two or more misting tips and hoses.

In an embodiment, the hose 202 branches out past the mist elbow 208 into two hoses 216, 218. A portion of the hoses 216, 218 may be adjustable metal coils. The adjustable metal coils allow the mist tips 204, 206 to be adjusted to a desired orientation by the user. The adjustable metal coils control the direction of the water exiting the misting tips 204, 206.

In another embodiment, the valves 210, 212 and the misting elbow 208 are placed behind the housing 220. The valves 210, 212 and the misting elbow 208 are mounted on the back of the housing 220 and away from the user.

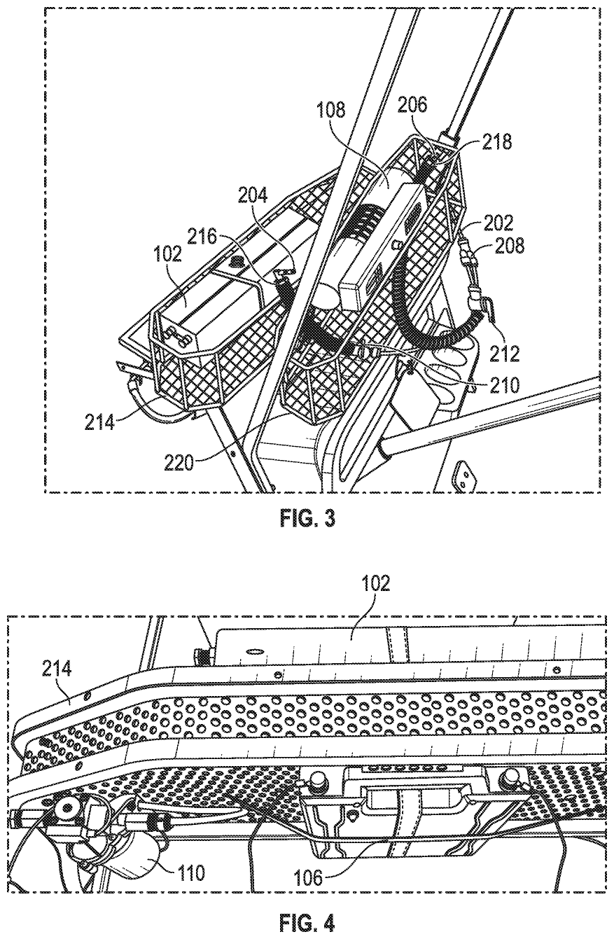

FIG. 3 is a side view of the system, according to an embodiment. The air blower 108 motor may be a DC electric motor. The battery 110 supplies power to the motor of the air blower 108. In another embodiment, the power for the motor may be come from the power inverter, which transfers the electricity to the air blower 108 via one or more electrical cables.

FIG. 4 is a bottom view of the battery and the water pump of the system, according to an embodiment. The battery 110 connects to the water pump 106 and powers the water pump 106. In another embodiment, the battery 110 may connect to the power inverter, which connects to the water pump 106 and the air blower 108.

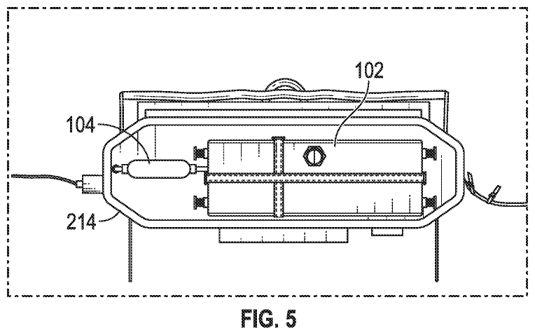

FIG. 5 is a top view of the water tank and the housing of the system, according to an embodiment. The water tank 102 has an interior cavity that is capable of containing a supply of water. The water tank may 102 be airtight and watertight. The water tank 102 is coupled to the vehicle and mounted on the housing 214. The water pump 106 is in liquid communication with the water tank 102. A water filter 104 collects from water tank 102 and removes any debris and particles from the water that may clog the misting tips 204, 206.

In an embodiment, a control panel may be included in the system. The control panel may include an on and off switch that controls the power supply to the entire cooling system. The control panel may be used to the control the air pressure of the air blower 108. The control panel may be connected to the battery 110 and used to control the power of the water pump 106. The control panel provides the user the ability to control the amount of cooling as desired by controlling the delivery rate of the mist. The control panel has one or more electrical cables. In an example, electrical cables may extend to the air blower 108 to control the power of the air blower 108. In an example, the air blower 108 may be one or more fans and the control panel may be coupled to the fan motor to control the speed of the fan.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

While the disclosure has been particularly shown and described with reference to specific embodiments thereof, it will be understood by those skilled in the art that the foregoing and other changes in form and details may be made therein without departing from the spirit and scope of the invention.

What is claimed is:

1. A system for cooling an open air vehicle, the system comprising:
a housing mounted on the open air vehicle configured to hold a water tank;
a water pump in liquid communication with the water tank, via one or more hoses;
one or more air blowers coupled to the water pump;
a battery configured to supply power to the water pump and the one or more air blowers; and
one or more misting tips in liquid communication with the water pump and distributes the water from the water pump.

2. The system of claim 1, wherein the one or more misting tips are configured within a predetermined distance of the one or more air blowers.

3. The system of claim 1, further comprising a water filter for removing particles from the water.

4. The system of claim 3, wherein the water filter is placed between the water tank and the water pump.

5. The system of claim 3, wherein the one or more air blowers comprise one or more fans having a plurality of different speeds.

6. The system of claim 5, wherein the one or more air blowers comprise one or more vents for directing the air outwards towards a user.

7. The system of claim 1, further comprising a battery charger to charge the battery.

8. The system of claim 1, wherein the one or more misting tips have a position that is adjusted by one or more metal coils.

9. The system of claim 1, wherein the open air vehicle is a golf cart.

10. A method for cooling an open air vehicle, the method comprising:
storing water in a water tank the water tank positioned within a housing on the open air vehicle;
powering a water pump, via a battery, the water pump in liquid communication with the water tank;
pumping water from the water pump through one or more hoses, the one or more hoses having one or misting tips on each end of the hoses; and
providing one or more air blowers that distributes cold air and water flowing out of the misting tips.

11. The method of claim 10, wherein the battery is charged by a battery charger.

12. The method of claim 10, wherein the one or more air blowers are one or more fans have a plurality of different speeds.

13. The method of claim 10, wherein the one or more misting tips are configured within a predetermined distance of the one or more air blowers.

14. The method of claim 10, wherein the open air vehicle is a golf cart.
